(19) United States
(12) Patent Application Publication
(10) Pub. No.: US 2026/0122008 A1
(43) Pub. Date: Apr. 30, 2026

(54) METHOD AND APPARATUS FOR MESSAGE ROUTING BETWEEN DIFFERENT NETWORK NODES IN 6G NETWORK ARCHITECTURE

(71) Applicant: SAMSUNG ELECTRONICS CO., LTD., Suwon-si, Gyeonggi-do (KR)

(72) Inventors: Neha SHARMA, Bangalore (IN); Meghna KHATURIA, Bangalore (IN); Jinho CHOI, Suwon-si (KR); Anshuman NIGAM, Bangalore (IN); Dongmyoung KIM, Suwon-si (KR)

(21) Appl. No.: 19/118,740

(22) PCT Filed: Oct. 5, 2023
(86) PCT No.: PCT/KR2023/015362

§ 371 Date: Apr. 4, 2025

(30) Foreign Application Priority Data
Oct. 7, 2022 (IN) 202241057366
Sep. 19, 2023 (IN) 202241057366

(51) Int. Cl. H04L 49/25; H04L 45/74; H04L 49/35

(52) U.S. Cl. CPC H04L 49/25; H04L 45/74; H04L 49/35

(57) ABSTRACT

The present disclosure relates to a 5G communication system or a 6G communication system for supporting higher data rates beyond a 4G communication system such as long term evolution (LTE). The HUB module includes at least one processor and a programmable switch that includes a table of flow entries to route the message. The at least one processor are configured to receive the message from a source UE among the at least one UE. The at least one processor are further configured to map at least one relevant field of a header of the message with the table of flow entries included in the programmable switch. The at least one processor are further configured to route the message to a destination NF module among the at least one NF module based on a result of the mapping of the at least one relevant field.

### TECHNICAL FIELD

The present disclosure relates to a field of wireless communication networks. More particularly, the present disclosure relates to a method and apparatus for message routing between different network nodes in Sixth Generation (6G) network architecture.

### BACKGROUND ART

Considering the development of wireless communication from generation to generation, the technologies have been developed mainly for services targeting humans, such as voice calls, multimedia services, and data services. Following the commercialization of 5G (5th generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bit per second (bps) and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz (THz) band (for example, 95 gigahertz (GHz) to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, Radio Frequency (RF) elements, antennas, novel waveforms having a better coverage than Orthogonal Frequency Division Multiplexing (OFDM), beamforming and massive Multiple-input Multiple-Output (MIMO), Full Dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, Orbital Angular Momentum (OAM), and Reconfigurable Intelligent Surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, High-Altitude Platform Stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of Artificial Intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as Mobile Edge Computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended Reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

### DISCLOSURE OF INVENTION

### Technical Problem

Currently, there are needs to enhance message routing between different network nodes in Sixth Generation (6G) network architecture.

### Solution to Problem

This summary is provided to introduce a selection of concepts, in a simplified format, that are further described in the detailed description of the invention. This summary is neither intended to identify key or essential inventive concepts of the invention nor is it intended for determining the scope of the invention.

In an embodiment, disclosed is a HUB module for routing a message between one or more User Equipments (UEs) and one or more Network Function (NF) modules in a communication network. The HUB module comprises a programmable switch and one or more processors. The programmable switch includes a table of flow entries to route the message. The one or more processors are configured to receive the message from a source UE among the one or more UEs and map one or more relevant fields of a header of the message with the table of flow entries included in the programmable switch. Furthermore, the one or more processors are configured to route the message to a destination NF module among the one or more NF modules based on a result of the mapping of the one or more relevant fields.

In one or more embodiments, the one or more processors are configured to receive the message from a source NF module among the one or more NF modules and map one or more relevant fields of a service based interface (SBI) header of the message with the table of flow entries included in the programmable switch. Furthermore, the one or more processors are configured to route the message to a destination UE among the one or more UEs based on a result of the mapping of the one or more relevant fields.

In yet another embodiment, disclosed herein is a method implemented at the HUB module for routing the message between the one or more UEs and the one or more NF modules in the communication network. The method comprises receiving the message from a source UE among the one or more UEs and mapping one or more relevant fields of a header of the message with a table of flow entries included in a programmable switch of the HUB module. The method further includes routing the message to a destination NF module among the one or more NF modules based on a result of the mapping of the one or more relevant fields.

In one or more embodiments, the method comprises receiving the message from a source NF module among the one or more NF modules and mapping one or more relevant fields of a service based interface (SBI) header of the message with a table of flow entries included in a programmable switch of the HUB module. Subsequently, the method comprises routing the message to a destination UE among the one or more UEs based on a result of the mapping of the one or more relevant fields.

To further clarify the advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF DRAWINGS

These and other features, aspects, and advantages of the present invention will become better understood when the following detailed description is read with reference to the accompanying drawings in which like characters represent like parts throughout the drawings, wherein:

FIG. 1 illustrates a block diagram depicting a Sixth Generation (6G) network architecture, in accordance with one or more embodiments of the present disclosure;

FIG. 2A illustrates a diagram depicting a design criteria of the HUB module of FIG. 1, in accordance with one or more embodiments of the present disclosure;

FIG. 2B illustrates a block diagram depicting a Layer message format (i.e., a new message format) to route source user equipment (UE)'s control message or source network function (NF)'s control message at the HUB module, in accordance with one or more embodiments of the present disclosure;

FIG. 3 illustrates a block diagram depicting a protocol architecture of the 6G network architecture where a packet data convergence protocol (PDCP) layer terminates at the HUB module, according to one or more embodiments of the present disclosure;

FIG. 4A illustrates a protocol stack where the new message format is added over the PDCP layer, according to one or more embodiments of the present disclosure;

FIG. 4B illustrates a protocol stack where the new message format is encapsulated in a header of the PDCP layer, according to one or more embodiments of the present disclosure;

FIG. 5 illustrates a block diagram depicting a protocol architecture of the 6G network architecture where the PDCP layer terminates at NF modules, according to one or more embodiments of the present disclosure;

FIG. 6 illustrates an example of a protocol stack when the PDCP layer terminates at the NF modules, according to one or more embodiments of the present disclosure;

FIG. 7 illustrates an example of a processing of control message from a source UE towards a destination NF module, according to one or more embodiments of the present disclosure;

FIG. 8 illustrates a flow chart of a method for routing the control message from the source UE towards the destination NF module, according to one or more embodiments of the present disclosure;

FIG. 9 illustrates an example of a processing of the control message from a source NF module towards a destination UE, according to one or more embodiments of the present disclosure;

FIG. 10 illustrates a flow chart of a method for routing the control message from the source NF module towards the destination UE, according to one or more embodiments of the present disclosure;

FIG. 11 is a block diagram illustrating a structure of a UE according to an embodiment of the disclosure;

FIG. 12 is a block diagram illustrating a structure of a base station according to an embodiment of the disclosure; and

FIG. 13 is a block diagram illustrating a structure of a network entity according to an embodiment of the disclosure.

Further, skilled artisans will appreciate that those elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### BEST MODE FOR CARRYING OUT THE INVENTION

In recent years, several broadband wireless technologies have been developed to meet the growing number of broadband subscribers by providing better applications and services. Second Generation (2G) wireless communication system has been developed to provide voice services while ensuring the mobility of users. Third Generation (3G) wireless communication system supports not only voice service but also data service. In recent years, a Fourth Generation (4G) wireless communication system has been developed to provide high-speed data service. However, currently Fourth Generation (4G) wireless communication system suffers from a lack of resources to meet the growing demand for high-speed data services. This problem is solved by the deployment of a Fifth Generation (5G) wireless communication system to meet the ever-growing demand for high-speed data services. Furthermore, the 5G wireless communication system provides ultra-reliability and supports low-latency applications.

The 5G service-based system architecture is based on the service-based interface but an interaction between a Radio Access Network (RAN) to a Core Network (CN) is still a point-to-point (P2P) interaction. Due to network function virtualization, the RAN as well as the core network may be at the same location but still, the RAN can only interact with a single core network function entity i.e., Access and Mobility Management Function (AMF). The RAN as well as the AMF becomes an anchor for all User Equipment (UE) control messages, and each message has to pass through these network entities which is inefficient as it impacts overall control plane latency. As the RAN and the core network NFs may be collocated, there is no need to have two anchor points for UE messages. This also leads to an increased number of hops for control message delivery and eventually increases the control plane latency.

Therefore, P2P communication between different network nodes leads to an increase in overhead at the network nodes and control procedure completion time due to the involvement of multiple nodes. The P2P communication also leads to redundant functionalities in the RAN and the core network and uses complex protocols like NGAP (NG Application protocol) to communicate between any two nodes.

Thus, there is a need to design a more flexible and simple network architecture for 6G communication systems that can overcome the various aforementioned issues and provide a degree of freedom for NF placement due to cloudification and virtualization of the network.

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment”, and similar language throughout this specification may, but do not necessarily, all refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components preceded by “comprises . . . a” does not, without more constraints, preclude the existence of other devices or other sub-systems or other elements or other structures or other components or additional devices or additional sub-systems or additional elements or additional structures or additional components.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of modules that carry out a described function or functions. These modules, which may be referred to herein as units or blocks or the like, or may include blocks or units, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the invention.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

Embodiments of the present disclosure will be described below in detail with reference to the accompanying drawings.

In an embodiment, disclosed herein is a HUB module for routing a message between one or more User Equipments (UEs) and one or more Network Function (NF) modules in a communication network. The HUB module comprises a programmable switch and one or more processors. The programmable switch includes a table of flow entries to route the message. The one or more processors are configured to receive the message from a source UE among the one or more UEs and map one or more relevant fields of a header of the message with the table of flow entries included in the programmable switch. Furthermore, the one or more processors are configured to route the message to a destination NF module among the one or more NF modules based on a result of the mapping of the one or more relevant fields.

In one or more embodiments, the one or more processors are configured to receive the message from a source NF module among the one or more NF modules and map one or more relevant fields of a service based interface (SBI) header of the message with the table of flow entries included in the programmable switch. Furthermore, the one or more processors are configured to route the message to a destination UE among the one or more UEs based on a result of the mapping of the one or more relevant fields.

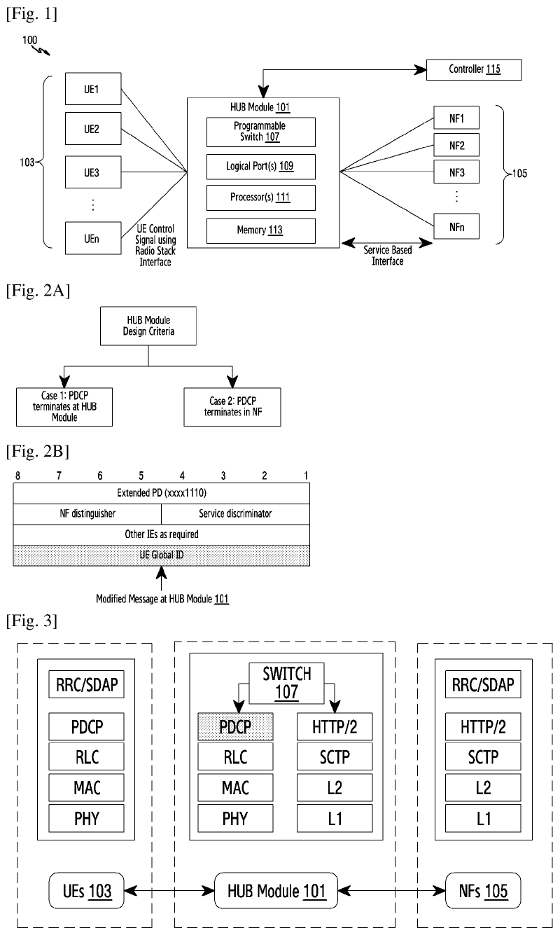

FIG. 1 illustrates a block diagram depicting a Sixth Generation (6G) network architecture 100, in accordance with one or more embodiments of the present disclosure. In the 6G network architecture 100, one or more UEs 103 interacts with one or more NF modules 105 through a HUB module 101. In other words, as shown in FIG. 1, the 6G network architecture includes a RAN module till the HUB module 101, and beyond that, one or more NF modules 105 (i.e., also referred to as “control plane NF modules 105” or “NF modules 105”). In an embodiment, the control plane NF modules 105 may belong to different services like connection management, session management, handovers, service requests, etc. In one or more embodiments, the terms “NF modules 105” and “control plane NF modules 105” have been used interchangeably throughout the present disclosure. Also, the terms “HUB module 101” and “HUB 101” have been used interchangeably throughout the present disclosure without deviating from the scope of the present disclosure.

As shown in FIG. 1, the one or more UEs 103 may interact with any of the NF modules 105 in the 6G network architecture 100. Each of the NF modules 105 may be controlled by the HUB module 101. In such a case, the HUB module 101 becomes a single anchor point for all UE control messages that are received from the one or more UE 103. The HUB module 101 may be an independent module or an entity that provides an ability to directly exchange the control messages between the one or more UEs 103 and the NF modules 105. The HUB module 101 is forward placed at one of a Distributed unit (DU) (i.e., one HUB to one DU) or a first node of a virtualized network (i.e., one HUB to multiple DUs). The HUB module 101 may be connected to the DU(s) via a dedicated I/F through a south-bound, and to the NF modules 105 via a Service-based Interface (SBI) through a north-bound. The SBI interface may use HTTP/2 types or equivalent protocols for establishing connectivity between the HUB module 101 and the NF modules 105. In an embodiment, the terms “NF module” and “NF” have been used interchangeably throughout the present disclosure.

All the control message transmissions between the one or more UEs 103 and the HUB module 101 are managed through a single layer. For example, in case a source UE among the one or more UEs 103 wants to transmit a control message to the NF1 module of the network. Then, in that case, the UE's control message is first parsed at the HUB module 101, and thereafter the HUB module 101 delivers the UE control message directly to the NF1 module. In particular, when the source UE transmits its control message to the HUB module 101 through a UE control layer using a radio stack interface, then the HUB module 101 calls a corresponding service of an appropriate NF module among the NF modules 105 based on information included in the control message. Further, the appropriate NF module calls the message delivery service provided by the HUB module 101 to deliver the control messages to the source UE.

The HUB module 101 includes a programmable switch 107, logical ports 109, one or more processors 111 (also referred to as “processor(s) 111”), and a memory 113.

The programmable switch 107 includes a table of flow entries to route each of the control messages received from the one or more UEs 103 or the control messages that are received from the NF modules 105. The programmable switch 107 further includes an NF ID of each of the NF modules 105 and a UE global ID of each of the one or more UEs 103 within the network. For routing the UE's control message to a destination NF Module among the NF modules 105, the programmable switch 107 is configured to encapsulate a payload coming from the UE 103 into a service based message format using appropriate identifiers. For routing the NF's control message to the source UE, the programmable switch 107 is configured to remove the service based headers included in the NF's control message and send the payload by encapsulating the payload in a radio stack using the appropriate headers provided in the service based headers. In particular, the control messages include the payload along with header information associated with the source UE or the destination NF module, or vice versa. It is to be noted that the terms “programmable switch” and “switch” are used interchangeably throughout the disclosure without any deviation from the scope of the disclosure.

The logical ports 109 include a UE specific logical port and an NF specific logical port. The UE specific logical port is configured to process the control message received from the source UE. The NF specific logical port is configured to process the control message received from a source NF module among the NF modules 105. The logical ports 109 are switch-defined ports that do not correspond directly to hardware interfaces on the programmable switch 107. In particular, an abstraction is created on a physical port mapped to an NF module and the same can be referred to as a logical port. The logical ports 109 are introduced at the physical port (DU side) of the HUB module 101 to perform PDCP/RLC header processing. Each of the NF modules 105 is mapped to separate logical ports among the logical ports 109.

The processor 111 can be a single processing unit or several units, all of which could include multiple computing units. The processor 111 may be implemented as one or more microprocessors, microcomputers, microcontrollers, digital signal processors, central processing units, state machines, logic circuitries, and/or any devices that manipulate signals based on operational instructions. Among other capabilities, the processor 111 is configured to fetch and execute computer-readable instructions and data stored in the memory 113.

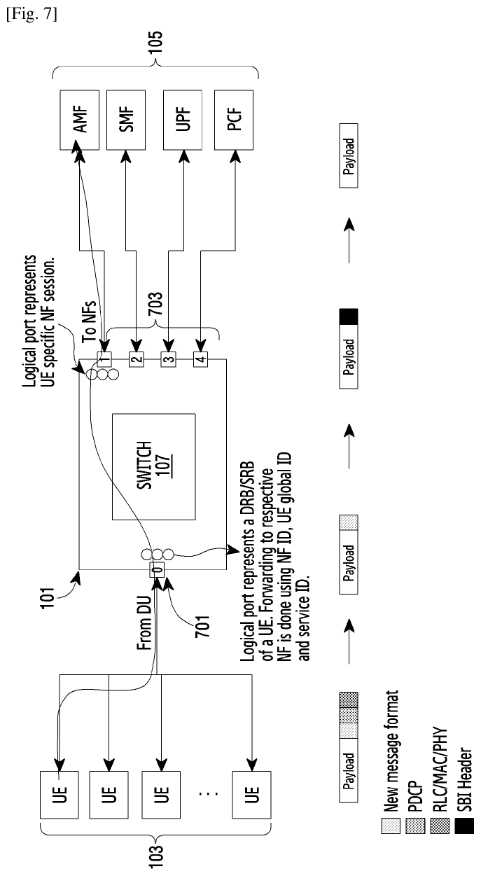

The memory 113 includes one or more computer-readable storage media. The memory 113 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory may, in some examples, be considered a non-transitory storage medium. The term “non-transitory” may indicate that the storage medium is not embodied in a carrier wave or a propagated signal. However, the term “non-transitory” should not be interpreted to mean that the memory is non-movable. In certain examples, a non-transitory storage medium may store data that can, over time, change (e.g., in Random Access Memory (RAM) or cache. The memory 113 may further include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes. The memory 113 may be communicatively coupled with the processor 111 to store processing instructions for performing one or more operations as shown in FIGS. 7 through 10 of drawings.

The processor 111 is configured to receive the control message from the source UE as well as the source NF. The processor 111 is further configured to map one or more relevant fields of a header of the control message with the table of flow entries included in the programmable switch 107. When the processor 111 receives the control message from the source UE, then the processor 111 maps the one or more relevant fields of the header of the UE's control message with the table of flow entries to route the control message received from the source UE to the destination NF module. Further, when the processor 111 receives the control message from the source NF module, then the processor 111 maps one or more relevant fields of a service based interface (SBI) header of the source NF's control message with the table of flow entries included in the programmable switch 107 to route the control message received from the source NF module to a destination UE among the one or more UEs 103. Accordingly, the processor 111 routes the UE's control message to the destination NF module based on a result of the mapping of the one or more relevant fields of the UE's control message with the table of flow entries. Similarly, the processor 111 routes the source NF's control message to the destination UE based on a result of the mapping of the one or more relevant fields of the source NF's control message with the table of flow entries.

The HUB module 101 is managed by a controller 115 which can be a part of a core network or an access network of the 6G network architecture 100. The controller 115 is communicatively coupled with the HUB module 101 and is responsible for setting appropriate flows in the programmable switch 107.

FIG. 2A illustrates a diagram depicting a design criteria of the HUB module 101 of FIG. 1, in accordance with one or more embodiments of the present disclosure. The HUB module 101 is designed based on where a Packet Data Convergence Protocol (PDCP) layer terminates. The PDCP layer is a part of Control Unit (CU) and is mostly located in cloud. However, the PDCP layer can also be located in the access network based on latency concerns. In a first example case, if an operator wants a bearer to terminate at the access network, then the PDCP layer can be located at the access network. In such a scenario, the PDCP layer terminates at the HUB module 101. Further, in a second example case, if the operator wants to allocate separate bearers to each of the NF modules 105, then in such cases, the PDCP layer terminates at the NF modules 105.

The PDCP layer in the access network is equivalent to the HUB module 101 located at the CU. The core idea is to avoid radio resource control (RRC) processing of the control messages as the RRC processing adds additional processing delays. Therefore, in one or more embodiments, the HUB module 101 performs the routing of control messages just after the PDCP layer.

In an embodiment, the processor 111 of the HUB module 101 deploys the PDCP layer as a part of a UE interface stack at the HUB module 101. When the PDCP layer is deployed at the HUB module 101, the PDCP layer is modified to include a new message format (described below in conjunction with FIG. 2B). In this scenario, the new message format can be added over the PDCP layer or can be encapsulated in the PDCP layer.

In some embodiment, the processor 111 may deploy the PDCP layer at the NF modules 105. When the PDCP layer is deployed at the NF modules 105, then a radio link control (RLC) layer at the UE interface stack of the HUB module 101 is modified to include the new message format. In such a scenario, the new message format can be added over the RLC layer.

FIG. 2B illustrates a block diagram depicting a Layer 3 message format 200 (i.e., the new message format) to route the source UE's control message or the source NF's control message at the HUB module 101, in accordance with one or more embodiments of the present disclosure. The terms “Layer 3 message format”, “new message format”, and “modified message format” are used interchangeably throughout the description without deviating from the scope of the present disclosure.

The Layer 3 message format 200 includes a plurality of fields including an extended preamble detection (PD) field, an NF distinguisher field, a service discriminator field, other IEs field as required by the HUB module 101, and a UE global ID field. The NF distinguisher field includes an NF ID to uniquely identify the destination NF module corresponding to the source UE. The service discriminator field includes a service ID to identify a service of the destination NF module to be accessed by the source UE. The UE global ID field includes a UE global ID of the source UE. The UE global ID is a 16-bit ID that is generated by an Access and Mobility Management Function (AMF) or by the controller 115. The processor 111 utilizes the UE global ID to map requests that come from the core network to a particular UE. The controller 115 may request the AMF to generate the UE global ID, and the AMF can generate the UE global ID based on the request from the controller 115. In some embodiments, the controller 115 may also generate the UE global ID. The processor 111 utilizes the UE global ID to route traffic from the source UE to the destination NF module effectively.

FIG. 3 illustrates a block diagram depicting a protocol architecture of the 6G network architecture 100 where the PDCP layer terminates at the HUB module 101, according to one or more embodiments of the present disclosure. As shown in FIG. 3, the PDCP layer is part of the UE interface stack at the HUB module 101. In order to have identifiers that uniquely determine the source UE and destination NFs for successful communication, the programmable switch 107 or the controller 115 can further have a database for all NF IDs and UE IDs, which can maintain all information like mapping between these UE IDs and NF IDs.

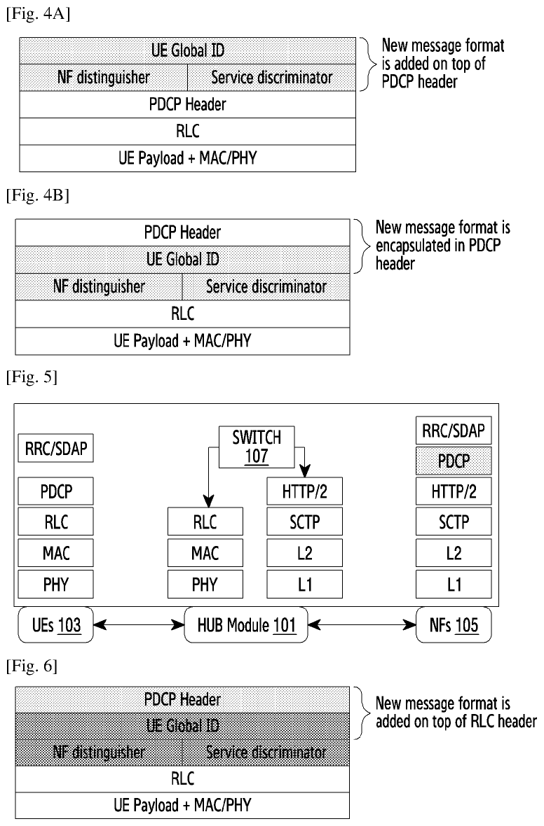

FIG. 4A illustrates a protocol stack where the new message format is added over the PDCP layer, according to one or more embodiments of the present disclosure. In an example embodiment as shown in FIG. 4A, at the PDCP layer, the processor 111 modifies a format of the UE's control message to contain the NF ID, Service ID, and the UE global ID. The UE global ID can be provided by the network through any RRC message or broadcast message or any other layer 1 or layer 2 messages during configuration or reconfiguration. In an embodiment, the source UE can get the UE global ID from the network during an initial connection and then maintain the UE global ID in a UE database. The network can also send a list of NF IDs, a list of NF distinguishers, or a list of Service Discriminators (SDs) corresponding to the NF IDs. The service discriminator can be used by the source UE to access a specific service within the destination NF module. Further, each of the NF IDs may have multiple SDs. In a non-limiting example, NF ID=1 can correspond to SD=1, 2, etc. The source UE as well as the HUB module 101 or the network may add this information before providing the control message to the PDCP layer. In another non-limiting example, NF ID=1 can correspond to SD=1, 2, etc. The source UE as well as the HUB module 101 or the network may add this information before providing the control message to the PDCP layer.

FIG. 4B illustrates a protocol stack where the new message format is encapsulated in a header of the PDCP layer, according to one or more embodiments of the present disclosure. In an example embodiment as shown in FIG. 4B, the processor 111 modifies the format of the UE's control message to encapsulate the NF ID, Service ID, and the UE global ID in the header of the PDCP layer. The UE global ID can be provided by the network through any RRC message or broadcast message or any other layer 1 or layer 2 messages during configuration or reconfiguration. It is to be noted that only a location of the new message format is changed. The IDs (i.e., NF ID, Service ID, and the UE global ID) that are encapsulated in the header of the PDCP layer are used by the HUB module 101 to uniquely determine from which UE the control message is coming and to which NF the control message needs to be transmitted or routed.

FIG. 5 illustrates a block diagram depicting a protocol architecture of the 6G network architecture 100 where the PDCP layer terminates at the NF modules 105, according to one or more embodiments of the present disclosure. As shown in FIG. 5, the PDCP layer is part of the NF modules 105 instead of the HUB module 101. In order to have identifiers that uniquely determine the destination UE and the source NF for successful communication, the programmable switch 107 or the controller 115 can further have a database for all NF IDs and UE IDs, which can maintain all information like mapping between these UE IDs and NF IDs. Accordingly, the HUB module 101 can uniquely identify the UE's control message for a required NF module among the NF modules 105 and the NF's control message for a required UE among the one or more UEs 103.

FIG. 6 illustrates an example of a protocol stack when the PDCP layer terminates at the NF modules 105, according to one or more embodiments of the present disclosure. In an example embodiment, as shown in FIG. 6, the processor 111 adds the new message format on top of the RLC layer. Also, the processor 111 adds relevant identifiers on top of the RLC layer. These identifiers are added in a header of the RLC layer and are used by the HUB module 101 to uniquely determine from which UE the control message is coming and to which NF the control message needs to be transmitted or routed.

FIG. 7 illustrates an example of a processing of the control message from the source UE towards the destination NF module, according to one or more embodiments of the present disclosure. As shown in FIG. 7, a UE specific logical port 701 among the logical ports 109 at the HUB module 101 may receive the control message from the source UE. In a non-limiting example, the HUB module 101 may include a dedicated logical port (i.e., the UE specific logical port 701) for the source UE.

Upon receiving the control message, the processor 111 is configured to control the UE specific logical port 701 to process the header of the PDCP layer and underlying layers as a part of logical port processing in the HUB module 101. The header of the PDCP layer includes information regarding the UE global ID, ingress port, the service ID, and the NF ID. As a non-limiting example, if the PDCP layer terminates at the HUB module 101, then the header information corresponding to the PDCP layer in the received control message contains the required fields to process the control message.

Upon processing the header of the PDCP layer using the UE specific logical port 701, the processor 111 maps the information included in the header of the PDCP layer with the table of flow entries included in the programmable switch 107. During mapping, the processor 111 is configured to match the received message with the one or more entries in the table of flow entries. Further, after mapping the information on the header, the processor 111 is configured to determine the destination NF module to route the control message from the source UE to the destination NF module based on the result of the mapping. When the information in the header matches with any entry on the table of flow entries, the processor 111 is configured to perform an action (as shown below in TABLE 1) based on an action present in corresponding entries of the table of flow entries. The action may correspond to forwarding the control message to one of an NF specific logical port among a plurality of NF specific logical ports 703, dropping the control message, enqueuing the control message for further processing, or sending the control message to the controller 115.

TABLE 1

| Match | Action | Description |
|---|---|---|
| NF ID = 1 | Send Message to | Message transmission |
| UE global ID = 100 | AMF identified | from UE to AMF |
| Ingress port = 0 | by NF ID = 1 | |
| NF ID = 2 | Send Message to | Message transmission |
| UE global ID = 100 | SMF identified | from UE to SMF |
| Ingress port = 0 | by NF ID = 2 | |

In a non-limiting example, in a first row of TABLE 1, the header information of the received control message includes NF ID=1, UE global ID=100, and Ingress port=0. As the NF ID=1, the corresponding action relates to sending the received control message to the AMF. Thus, the message with NF ID=1 is transmitted from the source UE to the destination NF module, for example, the AMF. In another non-limiting example, if the NF ID=2 then the corresponding action relates to sending the received control message to another destination NF module, for example, a Session Management Function (SMF). Further, based on determining the destination NF module from the table of flow entries, the HUB module 101 forwards the received control message to a corresponding NF specific logical port among the plurality of NF specific logical ports 703.

As shown in FIG. 7, the UE specific logical port 701 receives the control message from the source UE 103 that includes one or more header information. The header information corresponds to the new message format, information included in the header of the PDCP layer, and header information included in other layers (RLC/MAC/PHY). Thereby, the HUB module 101 determines the destination of the received control message and thereby encapsulates or adds above mentioned relevant headers into the UE's control message while transmitting the UE's control message to the destination NF module via the NF specific logical port. A format of the UE's control message including the relevant headers corresponds to the service based interface message format.

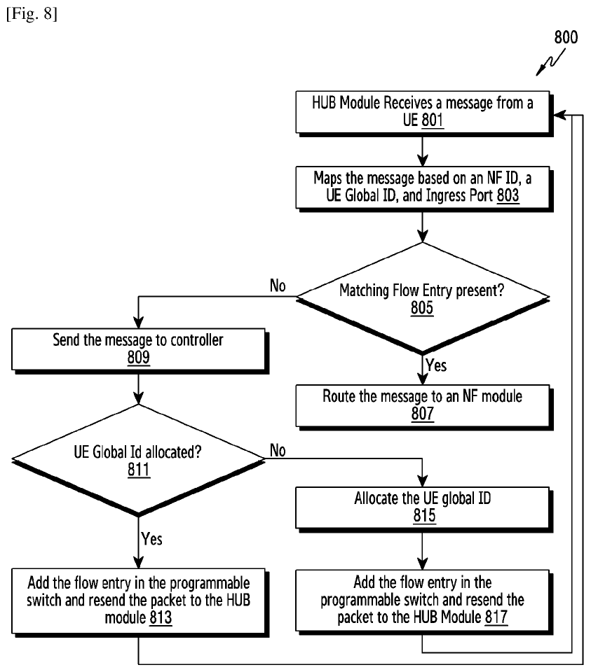

FIG. 8 illustrates a flow chart of a method 800 for routing the control message from the source UE towards the destination NF module, according to one or more embodiments of the present disclosure. The method 800 includes a series of operation steps 801 through 817. The operation steps 801 through 807 are performed by the processor 111 of the HUB module 101, whereas the operation steps 809 through 817 are performed by the controller 115 of the above-disclosed 6G network architecture 100 of FIG. 1.

In operation step 801, the processor 111 receives, at the UE specific logical port 701, the control message from the source UE among the one or more UEs 103.

In operation step 803, the processor 111 maps the received control message with the table of flow entries included in the programmable switch 107 of the HUB module 101. In particular, the processor 111 utilizes a logical port ID to direct the control message to a specific logical port, where the specific logical port parses the PDCP header to get the required fields such as the NF ID, UE Global ID, and the ingress port to match the control message with the table of flow entries included in the programmable switch 107. Accordingly, the processor 111 maps the NF ID, UE Global ID, and the ingress port with the table of flow entries included in the programmable switch 107 of the HUB module 101. The ingress port identifies from where the control message is coming, for example, if Ingress Port=1, then the control message is determined to be coming from the core network.

In operation step 805, the processor 111 determines, based on the result of the mapping, whether a flow entry in the table of flow entries is present corresponding to the one or more relevant fields included in the header of the received control message. If a result of the determination in the operation step 805 is yes, then the flow of the method 800 proceeds to operation step 807.

In operation step 807, the processor 111 routes the control message to the destination NF module among the NF modules 105. Further, If the result of the determination in the operation step 805 is No, then the flow of the method 800 proceeds to operation step 809.

In operation step 809, the processor 111 sends the received control message to the controller 115. Thereafter, the flow of the method 800 proceeds to operation step 811.

In operation step 811, the controller 115 determines whether or not the UE global ID is allocated to the source UE. If a result of the determination in the operation step 811 is yes, then the flow of the method 800 proceeds to operation step 813.

In operation step 813, the controller 115 adds the flow entry corresponding to the source UE in the table of flow entries and resends the control message to the HUB module 101. Further, If the result of the determination in the operation step 813 is No, then the flow of the method 800 proceeds to operation step 815.

In operation step 815, the controller 115 allocates the UE global ID to the source UE. In particular, if the source UE is communicating with the destination NF module for a first time and the NF ID can be allocated to the UE, then the controller 115 allocates the NF ID to the source UE. In an embodiment, if the source UE is not able to communicate with the destination NF module due to some security reason, then the controller 115 may also create a tunnel between the source UE and the destination NF module using a radio bearer. In such a scenario, the HUB module 101 may map the control message with the table of flow entries based on a radio bearer ID, the UE global ID, and the ingress port.

Once the UE global ID is allocated to the source UE, the flow of the method 800 proceeds to operation step 817.

In operation step 817, the controller 115 adds the flow entry corresponding to the source UE in the table of flow entries and resends the control message to the HUB module 101.

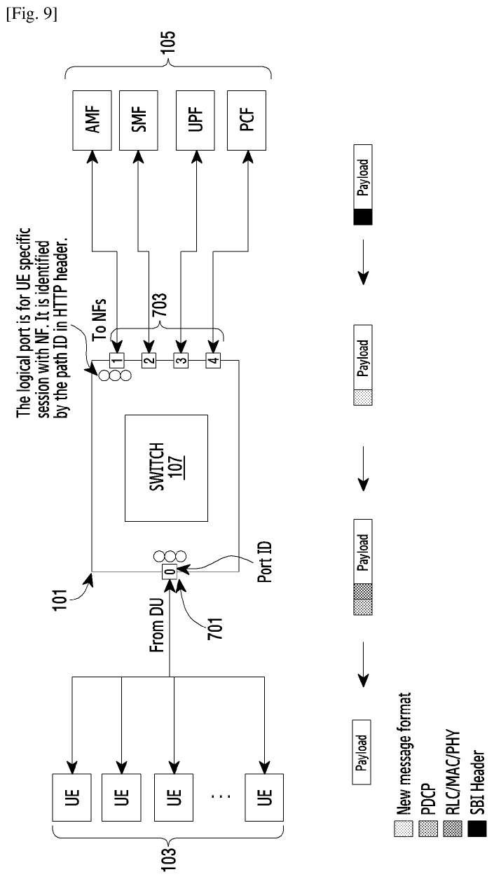

FIG. 9 illustrates an example of a processing of the control message from the source NF module towards the destination UE, according to one or more embodiments of the present disclosure. As shown in FIG. 9, an NF specific logical port among the plurality of NF specific logical ports 703 at the HUB module 101 may receive the control message from the source NF module. In a non-limiting example, the HUB module 101 may include a dedicated logical port (i.e., the NF specific logical port) for the source NF module.

Upon receiving the control message, the processor 111 is configured to control one of the NF specific logical port among the plurality NF specific logical ports 703 to process the SBI header of the NF's control message to extract information regarding the UE global ID. In one or more embodiments, the processor 111 may also utilize Uniform Resource Indicators (URIs) to process the SBI header of the NF's control message.

Upon processing the SBI header of the NF's control message, the processor 111 maps the information included in the SBI header with the table of flow entries included in the programmable switch 107. If the HUB module 101 is connected to more than one DU, then the processor 111 may utilize a DU ID to map the control message to a particular DU associated with the DU ID.

Further, after mapping the information on the SBI header, the processor 111 is configured to determine the destination UE to route the control message from the source NF module to the destination UE based on the result of the mapping. When the information in the SBI header matches with any entry on the table of flow entries, the processor 111 is configured to perform an action (as shown below in TABLE 2) based on an action present in corresponding entries of the table of flow entries. The action may correspond to forwarding the control message to the UE specific logical port 701, dropping the control message, enqueueing the control message for further processing, or sending the control message to the controller 115.

TABLE 2

| Match | Action | Description |
|---|---|---|
| UE global | Send AMF Packet to UE | Packet transmission |
| ID = 4 | with UE Global ID = 4 | from AMF to UE |
| UE global | Send UPF Packet to UE | Packet transmission |
| ID = 2 | with UE Global ID = 2 | from UPF to UE |

In a non-limiting example, in a first row of TABLE 2, the SBI header information of the received control message includes UE global ID=4. As the UE global ID=4, the corresponding action relates to sending the received control message to the source UE. Thus, in a non-limiting example, the control message with UE global ID=4 is transmitted from the source NF, for instance, the AMF to the destination UE. In another non-limiting example, if the UE Global ID=2 then the corresponding action relates to sending the received control message from another source NF module, for instance, UPF to another destination UE. Further, based on determining the destination UE from the table of flow entries, the HUB module 101 forwards the received control message to the UE specific logical port 701.

As shown in FIG. 9, one of the plurality of NF specific logical ports 703 receives the control message from the source NF module that includes SBI header information. Thereby, the HUB module 101 determines the destination of the received control message and thereby decapsulates or removes the SBI header information from the NF's control message while transmitting the NF's control message to the destination UE via the UE specific logical port 701. A format of the NF's control message including the SBI header corresponds to a radio stack interface message format. Also, the HUB module 101 adds, as the part of the logical port processing, the PDCP header to NF's control message while forwarding or transmitting the NF's control message to the destination UE.

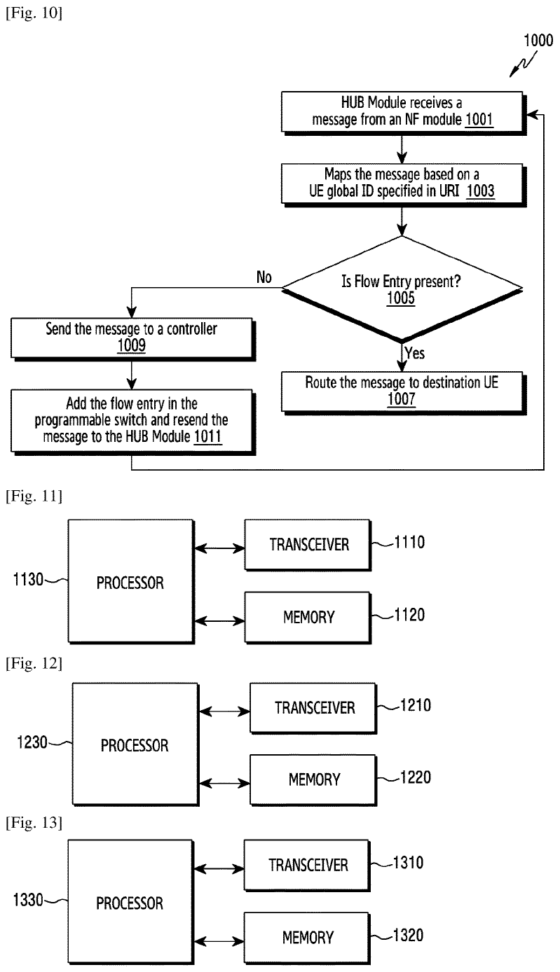

FIG. 10 illustrates a flow chart of a method 1000 for routing the control message from the source NF module towards the destination UE, according to one or more embodiments of the present disclosure. The method 1000 includes a series of operation steps 1001 through 1011. The operation steps 1001 through 1007 are performed by the processor 111 of the HUB module 101, whereas the operation steps 1009 and 1011 are performed by the controller 115 of the above-disclosed 6G network architecture 100 of FIG. 1.

In operation step 1001, the processor 111 receives, at one of the plurality of NF specific logical ports 703, the control message from the source NF module among the NF modules 105.

In operation step 1003, the processor 111 maps the received control message with the table of flow entries included in the programmable switch 107 of the HUB module 101. In particular, the processor 111 utilizes a logical port ID of the source NF module to direct the control message to a specific logical port, where the specific logical port parses the SBI header to get the required fields such as the UE Global ID specified in the URI to match the control message with the table of flow entries included in the programmable switch 107. Accordingly, the processor 111 maps the UE Global ID with the table of flow entries included in the programmable switch 107 of the HUB module 101.

In operation step 1005, the processor 111 determines, based on the result of the mapping, whether a flow entry in the table of flow entries is present corresponding to the one or more relevant fields included in the SBI header of the received control message. If a result of the determination in the operation step 1005 is yes, then the flow of the method 1000 proceeds to operation step 1007.

In operation step 1007, the processor 111 routes the control message to the destination UE after adding the PDCP header to the control message while forwarding or transmitting the control message to the destination UE. Further, If the result of the determination in the operation step 1005 is No, then the flow of the method 1000 proceeds to operation step 1009.

In operation step 1009, the processor 111 sends the received control message to the controller 115. Thereafter, the flow of the method 1000 proceeds to operation step 1011.

In operation step 1011, the controller 115 adds the flow entry corresponding to the one or more relevant fields included in the SBI header and resends the control message to the HUB module 101.

Now, referring to the technical effect and abilities of the present disclosure, the above-disclosed method provides various advantages. The advantages include providing a flexible HUB design and simple network architecture for the 6G communication systems that provide a degree of freedom for the NF placement due to cloudification and virtualization of the core network. Further, the above-disclosed HUB design architecture helps in reducing overhead at the NF modules and controlling procedure completion time due to the involvement of multiple NF modules.

FIG. 11 is a block diagram illustrating a structure of a UE according to an embodiment of the disclosure.

As shown in FIG. 11, the UE according to an embodiment may include a transceiver 1110, a memory 1120, and a processor 1130. The transceiver 1110, the memory 1120, and the processor 1130 of the UE may operate according to a communication method of the UE described above. However, the components of the UE are not limited thereto. For example, the UE may include more or fewer components than those described above. In addition, the processor 1130, the transceiver 1110, and the memory 1120 may be implemented as a single chip. Also, the processor 1130 may include at least one processor. Furthermore, the UE of FIG. 11 corresponds to the UEs (103) of FIGS. 1, 3, 5.

The transceiver 1110 collectively refers to a UE receiver and a UE transmitter, and may transmit/receive a signal to/from a base station or a network entity. The signal transmitted or received to or from the base station or a network entity may include control information and data. The transceiver 1110 may include a RF transmitter for up-converting and amplifying a frequency of a transmitted signal, and a RF receiver for amplifying low-noise and down-converting a frequency of a received signal. However, this is only an example of the transceiver 1110 and components of the transceiver 1110 are not limited to the RF transmitter and the RF receiver.

Also, the transceiver 1110 may receive and output, to the processor 1130, a signal through a wireless channel, and transmit a signal output from the processor 1130 through the wireless channel.

The memory 1120 may store a program and data required for operations of the UE. Also, the memory 1120 may store control information or data included in a signal obtained by the UE. The memory 1120 may be a storage medium, such as read-only memory (ROM), random access memory (RAM), a hard disk, a CD-ROM, and a DVD, or a combination of storage media.

The processor 1130 may control a series of processes such that the UE operates as described above. For example, the transceiver 1110 may receive a data signal including a control signal transmitted by the base station or the network entity, and the processor 1130 may determine a result of receiving the control signal and the data signal transmitted by the base station or the network entity.

FIG. 12 is a block diagram illustrating a structure of a base station according to an embodiment of the disclosure.

As shown in FIG. 12, the base station according to an embodiment may include a transceiver 1210, a memory 1220, and a processor 1230. The transceiver 1210, the memory 1220, and the processor 1230 of the base station may operate according to a communication method of the base station described above. However, the components of the base station are not limited thereto. For example, the base station may include more or fewer components than those described above. In addition, the processor 1230, the transceiver 1210, and the memory 1220 may be implemented as a single chip. Also, the processor 1230 may include at least one processor.

The transceiver 1210 collectively refers to a base station receiver and a base station transmitter, and may transmit/receive a signal to/from a terminal (UE) or a network entity. The signal transmitted or received to or from the terminal or a network entity may include control information and data. The transceiver 1210 may include a RF transmitter for up-converting and amplifying a frequency of a transmitted signal, and a RF receiver for amplifying low-noise and down-converting a frequency of a received signal. However, this is only an example of the transceiver 1210 and components of the transceiver 1210 are not limited to the RF transmitter and the RF receiver.

Also, the transceiver 1210 may receive and output, to the processor 1230, a signal through a wireless channel, and transmit a signal output from the processor 1230 through the wireless channel.

The memory 1220 may store a program and data required for operations of the base station. Also, the memory 1220 may store control information or data included in a signal obtained by the base station. The memory 1220 may be a storage medium, such as read-only memory (ROM), random access memory (RAM), a hard disk, a CD-ROM, and a DVD, or a combination of storage media.

The processor 1230 may control a series of processes such that the base station operates as described above. For example, the transceiver 1210 may receive a data signal including a control signal transmitted by the terminal, and the processor 1230 may determine a result of receiving the control signal and the data signal transmitted by the terminal.

FIG. 13 is a block diagram illustrating a structure of a network entity according to an embodiment of the disclosure.

As shown in FIG. 13, the network entity of the present disclosure may include a transceiver 1310, a memory 1320, and a processor 1330. The transceiver 1310, the memory 1320, and the processor 1330 of the network entity may operate according to a communication method of the network entity described above. However, the components of the terminal are not limited thereto. For example, the network entity may include more or fewer components than those described above. In addition, the processor 1330, the transceiver 1310, and the memory 1320 may be implemented as a single chip. Also, the processor 1330 may include at least one processor. Furthermore, the network entity illustrated in FIG. 13 may correspond to the NFs (105) illustrated in FIGS. 1, 3, 5, 7, and 9.

The transceiver 1310 collectively refers to a network entity receiver and a network entity transmitter, and may transmit/receive a signal to/from a base station or a UE. The signal transmitted or received to or from the base station or the UE may include control information and data. In this regard, the transceiver 1310 may include a RF transmitter for up-converting and amplifying a frequency of a transmitted signal, and a RF receiver for amplifying low-noise and down-converting a frequency of a received signal. However, this is only an example of the transceiver 1310 and components of the transceiver 1310 are not limited to the RF transmitter and the RF receiver.

Also, the transceiver 1310 may receive and output, to the processor 1330, a signal through a wireless channel, and transmit a signal output from the processor 1330 through the wireless channel.

The memory 1320 may store a program and data required for operations of the network entity. Also, the memory 1320 may store control information or data included in a signal obtained by the network entity. The memory 1320 may be a storage medium, such as ROM, RAM, a hard disk, a CD-ROM, and a DVD, or a combination of storage media.

The processor 1330 may control a series of processes such that the network entity operates as described above. For example, the transceiver 1310 may receive a data signal including a control signal, and the processor 1330 may determine a result of receiving the data signal.

The methods according to the embodiments described in the claims or the detailed description of the present disclosure may be implemented in hardware, software, or a combination of hardware and software.

When the electrical structures and methods are implemented in software, a computer-readable recording medium having one or more programs (software modules) recorded thereon may be provided. The one or more programs recorded on the computer-readable recording medium are configured to be executable by one or more processors in an electronic device. The one or more programs include instructions to execute the methods according to the embodiments described in the claims or the detailed description of the present disclosure.

The programs (e.g., software modules or software) may be stored in random access memory (RAM), non-volatile memory including flash memory, read-only memory (ROM), electrically erasable programmable read-only memory (EEPROM), a magnetic disc storage device, compact disc-ROM (CD-ROM), a digital versatile disc (DVD), another type of optical storage device, or a magnetic cassette. Alternatively, the programs may be stored in a memory system including a combination of some or all of the above-mentioned memory devices. In addition, each memory device may be included by a plural number.

The programs may also be stored in an attachable storage device which is accessible through a communication network such as the Internet, an intranet, a local area network (LAN), a wireless LAN (WLAN), or a storage area network (SAN), or a combination thereof. The storage device may be connected through an external port to an apparatus according the embodiments of the present disclosure. Another storage device on the communication network may also be connected to the apparatus performing the embodiments of the present disclosure.

In the afore-described embodiments of the present disclosure, elements included in the present disclosure are expressed in a singular or plural form according to the embodiments. However, the singular or plural form is appropriately selected for convenience of explanation and the present disclosure is not limited thereto. As such, an element expressed in a plural form may also be configured as a single element, and an element expressed in a singular form may also be configured as plural elements.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others. In an example, the module(s) and/or the unit(s) and/or model(s) may include a program, a subroutine, a portion of a program, a software component, or a hardware component capable of performing a stated task or function. As used herein, the module(s) and/or the unit(s) and/or model(s) may be implemented on a hardware component such as a server independently of other modules, or a module can exist with other modules on the same server, or within the same program. The module(s) and/or unit(s) and/or model(s) may be implemented on a hardware component such as processor one or more microprocessors, microcomputers, microcontrollers, digital signal processors, central processing units, state machines, logic circuitries, and/or any devices that manipulate signals based on operational instructions. The module(s) and/or unit(s) and/or model(s), when executed by the processor(s), may be configured to perform any of the described functionalities.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

The various actions, acts, blocks, steps, or the like in the flow diagrams may be performed in the order presented, in a different order, or simultaneously. Further, in some embodiments, some of the actions, acts, blocks, steps, or the like may be omitted, added, modified, skipped, or the like without departing from the scope of the invention.

Unless otherwise defined, all technical and scientific terms used herein have the same meaning as commonly understood by one ordinary skilled in the art to which this invention belongs. The system, methods, and examples provided herein are illustrative only and not intended to be limiting.

While specific language has been used to describe the present subject matter, any limitations arising on account thereto, are not intended. As would be apparent to a person in the art, various working modifications may be made to the method to implement the inventive concept as taught herein. The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment.

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A node (101) for routing a message between at least one user equipment (UE) (103) and at least one network function (NF) entity (105) in a wireless communication system, the node (101) comprising:
a programmable switch (107) including a table of flow entries to route the message; and
at least one processor (111) configured to:
receive, from a source UE among the at least one UE (103), the message
map at least one relevant field of a header of the message with the table of flow entries included in the programmable switch (107); and
transmit, to the destination NF entity among the at least one NF entity (105), the message based on a result of mapping of the at least one relevant field with the table of flow entries.

2. The node (101) as claimed in claim 1, wherein the at least one processor (111) is further configured to:
deploy a packet data convergence protocol (PDCP) layer as a part of a UE interface stack at the node (101), and
modify the PDCP layer to include a new message format, wherein the new message format is added over the PDCP layer or encapsulated in the PDCP layer and comprises the at least one relevant field.

3. The node (101) as claimed in claim 1, wherein the at least one processor (111) is further configured to:
deploy a packet data convergence protocol (PDCP) layer at the at least one NF entity (105), and
modify a radio link control (RLC) layer at a UE interface stack at the node (101) to include a new message format,
wherein the new message format is added over the RLC layer and comprises the at least one relevant field.

4. The node (101) as claimed in claim 1, wherein the at least one relevant field includes:
an NF distinguisher field including an NF ID to identify the destination NF entity corresponding to the source UE;
a service discriminator field including a service ID to identify a service of the destination NF entity to be accessed by the source UE; and
a UE global ID field including a UE global ID of the source UE.

5. A method (800) performed by a node (101) for routing a message between at least one User Equipment (UE) (103) and at least one Network Function (NF) entity (105) in a wireless communication system, the method (800) comprising:
receiving (801), from a source UE among the at least one UE (103), the message;
mapping (803) at least one relevant field of a header of the message with a table of flow entries included in a programmable switch (107) of the node (101); and
transmitting (807), to a destination NF module among the at least one NF module (105), the message based on a result of the mapping of the at least one relevant field with the table of flow entries.

6. The method (800) as claimed in claim 5, the method (800) further comprising:
deploying a packet data convergence protocol (PDCP) layer as a part of a UE interface stack at the node (101), and
modifying the PDCP layer to include a new message format, wherein the new message format is added over the PDCP layer or encapsulated in the PDCP layer and comprises the at least one relevant field.

7. The method (800) as claimed in claim 5, the method (800) further comprising:
deploying a packet data convergence protocol (PDCP) layer at the at least one NF entity (105), and
modifying a radio link control (RLC) layer at a UE interface stack at the node (101) to include a new message format, wherein the new message format is added over the RLC layer and comprises the at least one relevant field.

8. The method (800) as claimed in claim 5, wherein the at least one relevant field includes:
an NF distinguisher field including an NF ID to identify the destination NF entity corresponding to the source UE;
a service discriminator field including a service ID to identify a service of the destination NF entity to be accessed by the source UE; and
a UE global ID field including a UE global ID of the source UE.

9. A source user equipment (UE) in a wireless communication system, the source UE comprising:
a transceiver;
at least one processor (1130) connected with the transceiver and configured to transmit, to a node (101), a message, wherein the node (101) is for routing the message between at least one user equipment (UE) (103) including the source UE and at least one network function (NF) entity (105),
wherein at least one relevant field of a header of the message is mapped with a table of flow entries for routing the message.

10. The source UE as claimed in claim 9, wherein a packet data convergence protocol (PDCP) layer as a part of a UE interface stack at the node (101) includes a new message format comprising the at least one relevant field.

11. The source UE as claimed in claim 9, wherein a packet data convergence protocol (PDCP) layer at the at least one NF entity (105), includes a new message format comprising the at least one relevant field.

12. The source UE as claimed in claim 9, wherein the at least one relevant field includes:
an NF distinguisher field including an NF ID to identify a destination NF entity among the at least one NF entity (105), corresponding to the source UE;
a service discriminator field including a service ID to identify a service of the destination NF entity to be accessed by the source UE; and
a UE global ID field including a UE global ID of the source UE.

13. A method performed by a source user equipment (UE) in a wireless communication system, the method comprising:
transmitting, to a node (101), a message, wherein the node (101) is for routing the message between at least one user equipment (UE) (103) including the source UE and at least one network function (NF) entity (105),
wherein at least one relevant field of a header of the message is mapped with a table of flow entries for routing the message.

14. The method as claimed in claim 13,
wherein a packet data convergence protocol (PDCP) layer as a part of a UE interface stack at the node (101) includes a new message format comprising the at least one relevant field, or
wherein a packet data convergence protocol (PDCP) layer at the at least one NF entity (105), includes a new message format comprising the at least one relevant field.

15. The method as claimed in claim 13, wherein the at least one relevant field includes:
an NF distinguisher field including an NF ID to identify a destination NF entity among the at least one NF entity (105), corresponding to the source UE;
a service discriminator field including a service ID to identify a service of the destination NF entity to be accessed by the source UE; and
a UE global ID field including a UE global ID of the source UE.
